(19) United States
(12) Patent Application Publication
(10) Pub. No.: US 2016/0326022 A1
(43) Pub. Date: Nov. 10, 2016

(54) FILTRATION MODULE

(71) Applicant: Technion Research & Development Foundation Limited, Haifa (IL)

(72) Inventors: Carlos Dosoretz, Carmiel (IL); Avner Ronen, Zichron Yaakov (IL); Raphael Semiat, Haifa (IL)

(21) Appl. No.: 15/214,649

(22) Filed: Jul. 20, 2016

Related U.S. Application Data
(63) Continuation-in-part of application No. 13/771,219, filed on Feb. 20, 2013, now abandoned.
(60) Provisional application No. 61/601,102, filed on Feb. 21, 2012.

(51) Int. Cl. C02F 1/44

(52) U.S. Cl. CPC C02F 1/44; C02F 2303/20

(57) ABSTRACT

The present invention provides a filtration module having at least one membrane layer and a spacer layer, wherein the spacer includes: a polymeric matrix; and a biocide physically embedded into or attached to the polymeric matrix. Moreover, the invention provides a method for reducing the concentration of bacteria in water, by contacting water with the filtration module.

### CROSS REFERENCE TO RELATED APPLICATIONS

This application is a continuation-in-part (CIP) of U.S. patent application Ser. No. 13/771,219, filed on Feb. 20, 2013, which claims the benefit of priority of U.S. Provisional Patent Application No. 61/601,102, filed on Feb. 21, 2012 and entitled “Biofouling Prevention In Membrane Filtration Systems Using Composite Nanoparticles/Polymer Spacer”, which are all incorporated herein by reference in their entirety.

### FIELD OF INVENTION

This invention is directed to; inter alia, a filtration module having a biocide modified spacer directly contacting a membrane.

### BACKGROUND OF THE INVENTION

Antimicrobial modification of surfaces to prevent growth of detrimental microorganisms is a highly desired objective. Microbial infestation of surfaces is one of the leading causes of infections. This often leads to life threatening complications.

Water purification is the process of removing undesirable chemicals, biological contaminants such as bacteria, suspended solids and gases from contaminated water. The goal is to produce water fit for a specific purpose. Most water is purified for human consumption (drinking water). In general the methods used include physical processes such as filtration, sedimentation, and distillation, biological processes such as slow sand filters or biologically active carbon, chemical processes such as flocculation and chlorination and the use of electromagnetic radiation such as ultraviolet light.

Pressure driven-membrane separation processes are a key technology for water purification and production of new water sources. Membranes are susceptible to fouling. Biofouling is the most complex and difficult to solve form of fouling and hinders the utilization of membrane technology in many applications. Biofouling is defined operationally and refers to that amount of biofilm development which interferes with technical or economic requirements.

A biofilm is a microbial aggregate which occurs at the interface of any flowing system. Microorganisms are present in nearly all water treatment systems. They tend to adhere to surfaces and grow, mainly by using nutrients extracted from the water phase. A feature that all biofilms have in common is that the organisms are embedded in a matrix of microbial origin, consisting of extracellular polymeric substances (EPS). Once they form, biofilms can be very difficult to remove. The EPS impart the characteristic properties of biofilms, and among them the remarkable resistance to biocides that would otherwise kill it in the planktonic state (Flemming, 1997; Baker &Dudley, 1998.

In pressure driven-membrane separation systems, bacterial transport toward the membrane by permeate drag has been found to be a mechanism by which cross-flow filtration contributes to the buildup of a biofouling layer that was more dominant than transport of nutrients (Eshed et al., 2008). Development of biofouling on separation membranes results in a dramatic decrease of productivity, especially when nutrients are present in the feedwater, as is the case with wastewater effluents. Once biofouling is initiated, the most dramatic effect on membrane permeability decline might is probably due to the formation and accumulation of EPS (Ivnitsky et al., 2005; 2007).

Membrane filtration processes are classified according to the membrane pore sizes, which dictate the size of the particles they are able to retain (see table). The membranes are made from materials such as thin organic polymer films, metals or ceramics, depending on the application. They are manufactured in different forms such as hollow fibers or flat sheets, which are incorporated into housing modules designed to produce optimal hydrodynamic conditions for separation.

Complete systems comprise arrangements of modules, together with the interfaces and control systems needed to integrate them into the various process configurations. Multi-stage treatment purification typically begins with a pre-treatment stage to remove contaminants that would otherwise affect the downstream equipment. Methods such as activated carbon filtration may be used for chlorine removal, cartridge or deep-bed filters for particle removal, and softening agents to remove minerals that cause hardness in the water.

### SUMMARY OF THE INVENTION

In one embodiment, the present invention provides a filtration module comprising two membrane layers and a spacer layer, the spacer layer is sandwiched between the two membrane layers, wherein the spacer layer is in direct contact with the two membrane layers, wherein the spacer layer comprises (i) a polymer; and (ii) a biocide deposited on at least one upper layer surface of the polymer, wherein: (a) the two membrane layers are devoid of the biocide, and (b) at least 50% of an area of the upper layer surface of the polymer is covered by the biocide. In another embodiment, the polymer comprises polypropylene. In another embodiment, the polymer comprises polymethyl methacrylate (PMMA). In another embodiment, the two membrane layers are characterized by a pore size of 0.2 μm-500 μm. In another embodiment, the filtration module comprises a tubular shape and two permeable or a semi-permeable membrane layers, wherein an outer circumference of the module comprises or consists of a membrane layer. In another embodiment, the filtration module comprises a tubular shape and a coiled bilayer, the bilayer comprises a single permeable or semi-permeable membrane layer directly contacting the spacer layer, wherein an outer circumference of the module consists of the membrane layer.

In another embodiment, the filtration module comprises at least one membrane layer and a spacer layer, wherein the spacer comprises (i) a polymeric matrix; and (ii) biocide, wherein the biocide is physically embedded into or attached to the polymeric matrix.

In another embodiment, at least 90% of the area of the upper layer surface of the polymer is covered by the biocide. In another embodiment, the biocide is at concentration that ranges from about 4% to about 30%, by total weight of the spacer layer. In another embodiment, the biocide is a metal or a metal oxide. In another embodiment, the metal or the metal oxide are in the form of nanosized particles. In another embodiment, the metal is silver. In another embodiment, the biocide is physically deposited on the at least one upper layer surface of the spacer. In another embodiment, the biocide comprises a quaternary ammonium salt. In another embodiment, the biocide comprises a quaternary ammonium salt and a metal or a metal oxide.

In another embodiment, the present invention further provides a filtration module having a tubular shape. In another embodiment, an outer circumference of the filtration module consists of a membrane layer. In another embodiment, the filtration module is adapted for filtering water.

In another embodiment, the present invention further provides a method for reducing bacteria concentration in water, comprising the step of contacting water with the disclosed filtration module in an embodiment thereof.

### BRIEF DESCRIPTION OF THE DRAWINGS

FIG. 1 is a scheme of a membrane separation module (Membrane Technology and Applications, R. Baker 2004).

FIG. 2 is a bar graph showing the influence of contact time and particle size on antibacterial ability of zinc oxide (ZnO).

FIGS. 3A-B show a micrograph showing the antimicrobial activity of ZnO applied to surfaces. FIG. 3A: ZnO electrodeposited on aluminum plates as a function of ZnO deposition time. Inhibition zones are denoted by the circle. FIG. 3B: ZnO-PMMA casting-composite film showing an inhibition zone. PMMA: Polymethyl methacrylate.

FIGS. 4A-D show SEM micrographs of ZnO-PMMA embedded-composites at the end of the flow-through runs in the presence of a P. putida S-12 suspension (10³ CFU/ml for 48 hours at Re˜600). Left panels: control (virgin PMMA, ×5(FIG. 4A) and ×10(FIG. 4C)). Right panels: PMMA-ZnO (×5(FIG. 4B) and ×10(FIG. 4D)). CFU: colony-forming unit; SEM: scanning electron microscopy.

FIG. 5 is a view of the polyacrylamide composite with 3% ZnO-nanoparticles (np).

FIGS. 6A-D present micrographs of living bacteria remaining on LB agar-medium in Petri dishes, following direct contact in liquid medium of a 10⁶ CFU/ml P. putida S-12 suspension with PAA gel-composites with (control) and without 3% ZnO-np. Left panels: controls (1 hour top (FIG. 6A), 2 hours bottom (FIG. 6C)); Right panels: ZnO-np (1 hour top (FIG. 6B), 2 hours bottom (FIG. 6D)). PAA: polyacrylamide.

FIGS. 7A-D present SEM micrographs showing the influence of composite PAA-ZnO-nanoparticles on biofilm development in flow-through runs in the presence of a P. putida S-12 suspension (10⁸ CFU/ml) for 72 hours. SEM micrographs at the end of the runs. Left panels, FIGS. 7A and C: control without ZnO-np (PAA); FIGS. 7 B and D: composite PAA with ZnO-np (PAA ZnO). Numbers indicate magnification times 1,000.

FIG. 8 presents a bar graph showing the influence of ZnO-np on permeability decline in dead-end filtration on a 200 KDa polysulfone membrane fed with a 10⁵ CFU/ml P. putida S-12 suspension.

FIGS. 9A-D present SEM micrographs showing the influence of composite PMMA-ZnO-np spacer on biofilm development on a 200 KDa polysulfone membrane fed with a 10⁸ CFU/ml P. putida S-12 suspension in cross-flow regime. These SEM micrographs (FIG. 9A: PMMA control ×10K, FIG. 9B: PMMA ZnO ×10K, FIG. 9C: PMMA control ×50K, FIG. 9D: PMMA ZnO ×50K) of the membranes surface were taken at the end of the runs (˜72 hours), after dismounting the cells.

FIGS. 10A-C present SEM micrographs of commercial PP spacer treated by sonochemical deposition. (FIG. 10A) Surface of the spacer ×150. (FIG. 10B) Surface of the spacer (SE detector) ×30K. (FIG. 10C) Surface of the spacer (BSE detector) ×30K; dark—pp, white—ZnO np. PP: Polypropylene. BSE: backscattered electrons.

FIG. 11 is a graph showing the EDS analysis of the embedded ZnO material. EDS: energy-dispersive X-ray spectroscopy.

FIG. 12 is a micrograph showing the inhibition zone of the treated polypropylene spacer.

FIG. 13 is a graph showing the normalized flux (Fₚᵢ/Fₚ₀) of permeate through a 200KD PS membrane. Treated spacer showed a slower decrease of flux compared to the untreated spacer.

FIGS. 14A-B present HRSEM micrographs (×5K) of a commercial polypropylene spacer after 48 hours of exposure to flow with 10⁵ CFU·mL⁻¹ P. putida S12. FIG. 14A: unmodified spacer. FIG. 14B: modified spacer with silver nitrate and ammonium hydroxide. PS: polysulfone; HRSEM: high-resolution scanning electron microscopy.

FIGS. 15A-B present HRSEM micrographs (×5K) of polysulfone membranes (200 KD) adjacent to spacers after 48 hours of exposure to flow with 10⁶ CFU·mL⁻¹ P. putida S12. FIG. 15A: unmodified spacer; FIG. 15B: Modified spacer with silver nitrate and ammonium hydroxide.

FIGS. 16A-C present HRSEM micrographs of the polypropylene feed spacers. FIG. 16A: unmodified spacer (magnification ×10K). FIG. 16B: Surface of the nanosilver modified spacer, SE detector (magnification ×20K); FIG. 16C: Surface of the nanosilver modified spacer, BSE detector. Dark area represents polypropylene and bright area represents silver nanoparticles. SE: secondary electron.

FIGS. 17A-D present HRSEM micrographs of 200 kDa polysulfone ultrafiltration membrane adjacent to spacers after 230 hours of exposure to flow with 10⁴ CFU·mL⁻¹ mixed bacterial culture. Left: Membrane adjacent to unmodified spacer (control); Right: Membrane adjacent to modified spacer (treatment). FIGS. 17A,B: ×3K magnification; FIGS. 17C,D: ×5K magnification. Estimated concentration of bacteria attached per membrane area calculated by TOC measurement were 260±8.6 and 13±12.5 cells per 100 μm² for the control and treatment, respectively. TOC: Total organic carbon.

FIGS. 18A-D presents CLSM imaging of a 200 kDa polysulfone ultrafiltration membrane after 230 hours of exposure to flow with 10⁴ CFU·mL⁻¹ mixed bacterial cultures with an adjacent spacer. Top: CLSM images; Bottom: Imaris software analysis of CLSM images. FIG. 18 A,C: Membrane adjacent to unmodified spacer; FIGS. 18 B,D: Membrane adjacent to modified spacer. Live cells are stained in green (CTC) and dead cells in red (PI). CLSM: confocal laser scanning microscopy. CTC: 5-cyano-2,3-ditolyl tetrazolium chloride. PI: Propidium iodide.

FIG. 19 presents mean flux profile of the 200 kDa polysulfone membrane during a 230 hours flow experiment in a planar flow cell with exposure to 10⁴ CFU·mL⁻¹ mixed bacterial cultures. Initial permeability was 2.5±0.1 L·m⁻²·h⁻¹ per psi and inlet pressure was maintained at approx. 10 psi. Insets show a close-up view of the respective spacers at the end of the experiments (modified spacer-upper panel, and unmodified spacer-bottom panel).

FIG. 20 presents velocity field and silver ions distribution as a function of spacer configuration obtained by the numerical simulation of the flow near and around spacers. Top: flow velocity distributions. Bottom: silver ions concentration distributions. Spacer configurations: A—submerged, B—cavity, C—zigzag. Concentrations are scaled by the concentration at the spacer-liquid interface.

FIGS. 21A-B presents silver ions concentration profile near the upper membrane. Top: concentration gradients in the flow channel. Bottom: concentration profile near the membrane. FIG. 21A—cavity, FIG. 21B—zigzag.

FIG. 22 presents graph showing flux values obtained from flow simulation as a function of flow velocity and spacer configurations.

FIGS. 23A-C present typical HRSEM micrographs of the control and polyquaternary ammonium modified spacer surface. FIG. 23A: Control spacer, magnification ×5K. FIG. 23B: modified spacer after 28 hours of ATRP, magnification ×5K. FIG. 23C: Modified spacers after 28 hours of ATRP, magnification ×40K, arrows indicate two examples of ligand length (600-1600 nm). ATRP: Atom transfer radical polymerization.

FIGS. 24A-C present polyquaternary ammonium (pQA) salt activation of the spacers by atom transfer radical polymerization. FIG. 24A: Chemical structure of pDMAEMA ligand on the backbone of the polypropylene spacer after initial attachment of BPBriBu. FIG. 24B: Chemical structure of the active surface after amine quaternization. FIG. 24C: FTIR spectra of polyquaternary ammonium modified spacer. (graph a) Untreated polypropylene (control). (graph) Polypropylene modified with PDMAEMA. Adsoprtion bands at 1722 cm⁻¹ (C═O formation) are indicative of pDMAEMA bonds. pDMAEMA: poly(dimethylamino)ethyl methacrylate; BPBriBu: Benzophenonyl 2-bromoisobutyrate. FTIR: Fourier transform infrared spectroscopy.

FIGS. 25A-C present HRSEM micrographs of 200 kDa polysulfone membrane adjacent to spacers after 230 hours of exposure to flow in a planar flow-through cell at 0.15 m·s⁻¹ channel flow velocity. Feed consisted of synthetic tertiary effluents containing approx. 104 CFU·mL⁻¹ of a mixed bacterial culture. FIG. 25A: Membrane adjacent to the unmodified spacer. FIG. 25B: Membrane adjacent to pQA modified spacer. FIG. 25C: Membrane adjacent to nAg modified spacer. Magnification ×3K in all images. n: nano;

FIG. 26 presents mean flux profile of a 200 kDa polysulfone membrane during 230 hours cross-flow filtration. Initial permeability was 2.5±0.2 L·m⁻²·h⁻¹ per psi and inlet pressure was maintained at approx. 10 psi. Other conditions as as in FIG. 25.

### DETAILED DESCRIPTION OF THE INVENTION

In one embodiment, the present invention provides a filtration module. In another embodiment, the filtration module comprises a tubular shape. In another embodiment, the filtration module is adapted for filtering a polar liquid. In another embodiment, the filtration module is adapted for filtering water. In another embodiment, a filtration module having tubular shape is a spiral wound filtration module having a high surface area and compact volume as shown in FIG. 1. In another embodiment, the filtration module comprises water.

In another embodiment, the filtration module is a biocidal filtration module. In another embodiment, biocidal is antibacterial. In another embodiment, a biocidal filtration module prevents the formation of biofilms on a surface of the filtration module. In another embodiment, a biocidal filtration module prevents colonization of bacteria on a surface of the filtration module.

In some embodiments, the term “bacteria” refers to Gram-positive bacteria.

In some embodiments, the term “bacteria” refers to Gram-negative bacteria.

In some embodiments, the term “biofilm”, as used herein, refers to an aggregate of living cells which are stuck to each other and/or immobilized onto a surface as colonies. The cells are frequently embedded within a self-secreted matrix of extracellular polymeric substance (EPS), also referred to as “slime”, which is a polymeric sticky mixture of nucleic acids, proteins and polysaccharides.

As used herein, the term “prevent” in the context of the formation of a biofilm, indicates that the formation of a biofilm is essentially nullified or is reduced by at least 20%, at least 30%, at least 40%, at least 50%, at least 60%, at least 70%, at least 80%, at least 90%, including any value therebetween, of the appearance of the biofilm in a comparable situation lacking the presence of the biocide (e.g., silver or metal-oxide nanoparticles as described below).

Alternatively, “prevent” means a reduction to at least 15%, 10% or 5% of the appearance of the biofilm in a comparable situation lacking the presence of the nanoparticles or a composition of matter containing same. Methods for determining a level of appearance of a biofilm and bacteria are known in the art.

In another embodiment, the present invention provides a filtration module comprising a membrane and at least one feed spacer, wherein the at least one feed spacer comprises (i) a polymeric matrix; and (ii) material having antimicrobial activity, wherein material is physically embedded into or attached to the polymeric matrix. In another embodiment, the present invention provides a filtration module having anti-biofouling properties to the at least one feed spacer. In another embodiment, attached is physically attached. In another embodiment, physically embedded is polymer-embedded. In another embodiment, physically embedded is fixed firmly and deeply in a surrounding polymer. In another embodiment, physically embedded or physically attached is ingrained.

In another embodiment, the present invention provides an antibacterial surface modification of spacers of a spiral wound filtration module. In another embodiment, the present invention provides an antibacterial surface modification of spacers of a spiral wound filtration module for preventing biofouling. This novel composite prevents biofouling in filtration systems. In another embodiment, all surfaces of the spacer are modified with a biocide as described herein. In another embodiment, the biocide is applied to the spacer by coating or by physical embedment.

In another embodiment, the invention further provides a method for preventing biofilm formation and reducing the need for addition of cleaning chemicals by utilizing the filtration module as described herein. By using materials with proven antibacterial properties embedded in the spacer surface, the initial formation of biofilm is prevented in the membrane-spacer contact area. In another embodiment, the invention further provides a generic tool for preventing biofouling in filtration systems without the need of modifying the active/selective layer of the membranes. In another embodiment, the filtration module reduces bacteria concentration in water passing therethrough.

In another embodiment, the filtration module is utilized in spiral wound RO and NF. In another embodiment, the filtration module is utilized in polymeric depth filters. In another embodiment, the filtration module is utilized in polymeric filter fabrics. In another embodiment, the filtration module is utilized in irrigation equipment. In another embodiment, the filtration module is utilized in polymeric pipes and conduits.

In another embodiment, the invention further provides a method and a process for making the filtration module as described herein. In another embodiment, metal oxides and/or Zn or Ag nanoparticles were electrodeposited on gold coated-commercial polypropylene-PP spacer. In another embodiment, metal oxides and/or Zn or Ag oxides nanoparticles were prepared according to any method known to one of skill in the art. In another embodiment, metal oxides and or Zn or Ag oxides nanoparticles were further embedded and thus coated the spacer-polymer. In another embodiment, deposition of a nanoparticle comprising a biocide as described herein is performed by sonochemical deposition on polyprolpylene-PP. In another embodiment, deposition of a nanoparticle comprising a biocide as described herein is performed by casting on polymethyl methacrylate-PMMA (biocides such as: Ag₂O, ZnO). In another embodiment, deposition of a nanoparticle comprising a biocide as described herein is performed by entrapping in polyacrylamide-PAA. In another embodiment, these procedures resulted in a spacer composed of a polymeric matrix embedded with nanoparticles having antimicrobial activity.

In another embodiment, the term “metal oxide” describes natural, isolated and/or synthetically prepared metal oxide substances.

A metal oxide comprises one or more metal atoms and one or more oxygen atoms, wherein one or more of the metal atom(s) is in association with one or more oxygen atoms as further defined and discussed hereinafter. In another embodiment, the metal atoms and the oxygen atoms are joined together via ionic bonds, such that cations of the metal atoms are associated with oxygen anions.

In some embodiment, the term ‘sonochemistry’ refers to the study or use of sonochemical irradiation.

In another embodiment, ultrasonic irradiation is applied on a mixture (e.g., an aqueous solution) of metal precursors (e.g., metal ion salts) as described herein (e.g., zinc acetate dehydrate).

In another embodiment, the ultrasonic irradiation is applied by a Ti-horn apparatus.

In another embodiment, the ultrasonic irradiation frequency applied during the sonication is of about at least 10 kHz, and can be about 10 kHz, about 20 kHz, about 30 kHz, about 40 kHz, about 50 kHz, about 60 kHz, about 70 kHz, about 80 kHz, about 90 kHz, or about 100 kHz including any value therebetween, or higher values.

In an exemplary embodiment the ultrasonic irradiation frequency applied during the sonication is 20 kHz.

In another embodiment, water is clean water. In another embodiment, water is bacteria polluted water or water comprising contaminants such as bacteria. In another embodiment, water is drinking water. In another embodiment, the filtration module is aimed at protecting the health of living organisms such as humans. In another embodiment, the filtration module is aimed at reducing the pollution of water in streams, lakes, rivers, wetlands and other waterways. In another embodiment, water is raw water. In another embodiment, water is rain water. In another embodiment, water comprises bacteria and viruses. In another embodiment, water comprises bacteria that adversely affect the thyroid gland, the liver or other vital body organs. In another embodiment, water comprises an atmospheric chemical. In another embodiment, water comprises dust. In another embodiment, water comprises smoke. In another embodiment, water comprises a mineral. In another embodiment, water comprises strontium 90. In another embodiment, water comprises lead. In another embodiment, water is soft water. In another embodiment, water comprises a trace mineral.

In another embodiment, water passing through the filtration module as described herein are contaminated with bacteria. In another embodiment, water to be passed through the filtration module as described herein do not meet the standards of the US environmental protection agency (EPA) with respect to the concentration of bacteria and/or the presence of harmful bacteria. In another embodiment, bacteria infected water passing through the filtration module as described herein become disinfected with harmful bacteria. In another embodiment, bacteria contaminated water which passed through the filtration module become suitable drinking water according to the EPA standards.

In another embodiment, the filtration module as described herein reduces the concentration of bacteria in water by at least 1.5 folds. In another embodiment, the filtration module as described herein reduces the concentration of bacteria in water by at least 2.0 folds. In another embodiment, the filtration module as described herein reduces the concentration of bacteria in water by at least 2.5 folds. In another embodiment, the filtration module as described herein reduces the concentration of bacteria in water by at least 3 folds. In another embodiment, the filtration module as described herein reduces the concentration of bacteria in water by at least 3.5 folds. In another embodiment, the filtration module as described herein reduces the concentration of bacteria in water by at least 4 folds. In another embodiment, the filtration module as described herein reduces the concentration of bacteria in water by at least 4.5 folds. In another embodiment, the filtration module as described herein reduces the concentration of bacteria in water by at least 5 folds. In another embodiment, the filtration module as described herein reduces the concentration of bacteria in water by at least 6 folds.

In another embodiment, the filtration module as described herein renders contaminated water-drinkable according to EPS standards and thus reduces the risk of illness from waterborne bacteria. In another embodiment, the filtration module as described herein is used to avoid bacterial slimes in irrigation wells that can clog pumps and pipes. In another embodiment, the filtration module as described herein is used as a sanitation practice.

In another embodiment, the filtration module comprises two membranes and a spacer sandwiched between the membranes. In another embodiment, the two membranes and the spacer are in direct contact. In another embodiment, the filtration module comprises a tubular shape wherein the tubular shape is composed of two permeable or a semi-permeable membrane layers (or membranes) and a spacer layer sandwiched between the two membrane layers, wherein the outer circumference of the module consists a membrane layer, and wherein the spacer layer is physically embedded with a biocide. In another embodiment, the filtration module is adapted for filtering water.

In another embodiment, a membrane is a membrane composed of a thermoplastic polymer. In another embodiment, a membrane is a membrane comprising a pore size of 0.1 μm-1 mm. In another embodiment, a membrane is a membrane comprising a pore size of 0.1 μm-500 μm. In another embodiment, a membrane is a membrane comprising a pore size of 2 μm-300 μm. In another embodiment, a membrane is a membrane comprising a pore size of 5 μm-250 μm. In another embodiment, a membrane is a membrane comprising a pore size of 10 μm-200 μm. In another embodiment, a membrane is a polysulfone membrane. In another embodiment, a membrane is a 200 KD filtration membrane.

In another embodiment, the filtration module comprises a single membrane and a spacer contacting the single membrane. In another embodiment, the filtration module comprises a tubular shape composed of a coiled (or spiraled) bilayer. In another embodiment, the bilayer comprises a permeable or a semi-permeable membrane layer directly contacting a spacer layer. In another embodiment, the outer circumference of the filtration module consists a membrane layer and not a spacer layer. In another embodiment, the spacer layer is physically embedded with a biocide. In another embodiment, the membrane layer is free of a biocide. In another embodiment, the membrane layer is free of a metal oxide.

In another embodiment, the filtration module is adapted to filter contaminants such as heavy metals. In another embodiment, the membrane layers within the filtration module are adapted to filter contaminants such as heavy metals. In another embodiment, the spacer layer within the filtration module is adapted to reduce the concentration of live bacteria within water that are in contact with the filtration module. In another embodiment, the spacer layer within the filtration module is further adapted to sandwich the membrane layers.

In another embodiment, the membrane layers or membranes within the filtration module are two membranes. In another embodiment, the two membranes are permeable. In another embodiment, the two membranes are semi-permeable. In another embodiment, one membrane is permeable and the second membrane is semi-permeable.

In another embodiment, a spacer layer is placed and/or sandwiched between the two membrane layers. In another embodiment, the spacer layer comprises polypropylene. In another embodiment, a membrane forms the outer circumference of the module as described herein. In another embodiment, the outer circumference of the module as described herein comprises a membrane. In another embodiment, the spacer layer comprises a biocide. In another embodiment, a spacer layer comprising a biocide is a spacer layer wherein the biocide is physically embedded onto the spacer's surface. In another embodiment, a biocide as described herein is attached to or bound to a nanoparticle or a microparticle which is embedded onto the spacer's surface. In another embodiment, a biocide is a metal oxide.

In another embodiment, the nanoparticle is an inorganic antibacterial nanoparticle. In another embodiment, the nanoparticle is a novel engineered nanomaterial. In another embodiment, the nanoparticle is a carbon nanotube. In another embodiment, the nanoparticle is a metal-oxide nanoparticle. In another embodiment, the nanoparticle is a ZnO nanoparticle. In another embodiment, the nanoparticle is a silver nanoparticle.

In another embodiment, the average size (e.g., diameter, length) of the nanoparticle ranges from about 1 nanometer to 500 nanometers. In another embodiment, the average size of the nanoparticle ranges from about 1 nanometer to about 300 nanometers. In another embodiment, the average size of the nanoparticle ranges from about 1 nanometer to about 200 nanometers. In another embodiment, the average size of the nanoparticle ranges from about 1 nanometer to about 100 nanometers. In another embodiment, the average size of the nanoparticle ranges from about 1 nanometer to 50 nanometers, and in another embodiment, it is lower than 35 nm.

In another embodiment, the average size of the nanoparticle is about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30 nm, about 31 nm, about 32 nm, about 33 nm, about 34 nm, about 35 nm, about 36 nm, about 37 nm, about 38 nm, about 40 nm, about 42 nm, about 44 nm, about 46 nm, about 48 nm, or 50 nm, including any value therebetween.

The particle can be generally shaped as a sphere, a rod, a cylinder, a ribbon, a sponge, and any other shape, or can be in a form of a cluster of any of these shapes, or can comprises a mixture of one or more shapes.

In another embodiment, the nanoparticle is embedded within the spacer by sonochemical deposition. In another embodiment, the nanoparticle is embedded within the spacer by molecular layer deposition. In another embodiment, the nanoparticle is embedded within the spacer by ion sputtering. In another embodiment, the nanoparticle is embedded within the spacer by electrodeposition.

In another embodiment, the present invention provides for the first time a spacer having a biocide sandwiched between two membranes. In another embodiment, the present invention provides that the membranes are biocides free. In another embodiment, the present invention provides that the membranes are iron-oxide free. In another embodiment, biocide free is iron-oxide free. In another embodiment, the present invention provides that the spacer and not the membranes comprises a biocide. In another embodiment, the present invention is superior to the state of the art utilizing biocide modified membranes that hinder the membranal properties of membranes. In another embodiment, the present invention is superior to the state of the art utilizing biocide modified membranes that change the permeability and/or selectivity of the membranes.

In another embodiment, the present invention provides that a filtration module as described herein having a spacer comprising a biocide and one or two membranes that are biocide free has unexpected desired benefits over other filtration modules, these benefits include: durability, reduced biocide leakage, increased biocide properties, biofilm resistance, bacteria colonization resistance, and better output. In another embodiment, the present invention provides that a filtration module as described herein having a spacer comprising a biocide sandwiched between two membranes that are biocide free lasts longer compared to other filtration modules wherein the membrane is modified with a biocide. In another embodiment, the present invention provides that a filtration module as described herein having a spacer comprising a biocide sandwiched between two membranes that are biocide free has better flow parameters compared to other filtration modules wherein the membrane is modified with a biocide. In another embodiment, the present invention provides that a filtration module as described herein having a spacer comprising a biocide sandwiched between two membranes that are biocide free has better flow biocide properties compared to other filtration modules wherein the membrane is modified with a biocide. In another embodiment, other filtration modules are composed of the same membranes, biocide, spacer, particles (nano or micro) as the invention module wherein the biocide or biocide-particle is embedded in at least one membrane. In another embodiment, other filtration modules are composed of the same membranes, biocide, spacer, particles (nano or micro) as the invention's module wherein the biocide or biocide-particle is embedded in at least one membrane and not in a spacer.

In another embodiment, a biocide comprises a metal-oxide. In another embodiment, a biocide is ZnO. In another embodiment, a biocide is silver oxide. In another embodiment, a biocide is alumina (Al₂O₃). In another embodiment, a biocide is boron oxide (B₂O₃). In another embodiment, a biocide is a potassium oxide (K₂O). In another embodiment, a biocide is sodium oxide (Na₂O). In another embodiment, a biocide is iron oxide (Fe₂O₃). In another embodiment, a biocide is magnesium oxide (MgO). In another embodiment, a biocide is chlorine (Cl₂), hypochlorite ion and/or hypochlorous acid. In another embodiment, a biocide is chlorine dioxide (ClO₂). In another embodiment, a biocide is bromine (Br₂) or 1-bromo-3-chloro-5,5-dimthylhydantoin. In another embodiment, a biocide is copper oxide. In another embodiment, a biocide is nAg. In another embodiment, a biocide is TiO₂. In another embodiment, a biocide is silver nitrate. In another embodiment, a biocide is ammonium hydroxide.

In another embodiment, a spacer comprises at least 1% w/w biocide. In another embodiment, a spacer comprises at least 5% w/w metal or metal-oxide. In another embodiment, a spacer comprises at least 1-30% w/w metal or metal-oxide. In another embodiment, a spacer comprises at least 2-20% w/w metal or metal-oxide. In another embodiment, a spacer comprises at least 5-15% w/w metal metal-oxide. In another embodiment, a spacer comprises at least 8-12% w/w metal or metal-oxide. In another embodiment, a spacer as described herein comprises metal or metal-oxide mainly on its upper layer surface. In another embodiment, a spacer as described herein comprises metal or metal-oxide only on its upper layer surface. In another embodiment, a spacer as described herein comprises 0.5-20% w/w copper. In another embodiment, a spacer as described herein comprises 0.5-10% w/w copper. In another embodiment, a spacer as described herein comprises 1-5% w/w copper. In another embodiment, a spacer as described herein comprises 2.5-4.5 w/w copper.

In another embodiment, a spacer comprises at least 5% w/w silver. In another embodiment, a spacer comprises at least 1-30% w/w silver. In another embodiment, a spacer comprises at least 2-20% w/w silver. In another embodiment, a spacer comprises at least 5-15% w/w silver. In another embodiment, a spacer comprises at least 8-12% w/w silver.

In another embodiment, an upper layer surface of the spacer comprises e.g., 60%, 70%, 80, 90%, 95%, 99%, or 99.5% biocide, including any value therebetween.

In another embodiment, an upper layer surface of the spacer comprises e.g., 60%, 70%, 80, 90%, 95%, 99%, or 99.5% copper, including any value therebetween.

In another embodiment, an upper layer surface of the spacer comprises e.g., 60%, 70%, 80, 90%, 95%, 99%, or 99.5% (percent of the upper layer surface) silver, including any value therebetween.

In another embodiment, an upper layer surface of the spacer comprises e.g., 60%, 70%, 80, 90%, 95%, 99%, or 99.5% metal oxide, including any value therebetween.

Methods for determining percent of coating are known in the art, for example, using image processing of the secondary electron (SE) imaging.

In another embodiment, the present invention provides that the filtration module decreases the concentration of bacteria in water passing therethrough by at least half an order of magnitude. In another embodiment, the present invention provides that the filtration module decreases the concentration of bacteria in water passing therethrough by about (±15%) one order of magnitude.

In another embodiment, the present invention provides that the filtration module is a spiral wound module with novel bacterial sheet adhesion properties. In another embodiment, the present invention provides that the spacer is 100-5000 μm thick. In another embodiment, the present invention provides that the spacer is 200-2000 μm thick. In another embodiment, the present invention provides that the spacer is 400-1000 μm thick. In another embodiment, the present invention provides that the spacer is 600-800 μm thick.

In another embodiment, the present invention provides that a membrane is 20-4000 μm thick. In another embodiment, the present invention provides that a membrane is 500-2000 μm thick. In another embodiment, the present invention provides that a membrane is 100-1000 μm thick. In another embodiment, the present invention provides that a membrane is 100-500 μm thick. In another embodiment, the present invention provides that a membrane is 200-400 μm thick.

In an embodiment of the present invention, a functional group is chemically grafted to the spacer. In an embodiment the functional group is a side group of a polymer (referred to as “first polymer”).

In an embodiment, the functional group to undergo reaction with a second polymer to create a covalent bond between the first polymer and the second polymer.

In one embodiment, the first polymer and/or the second polymer are each grafted from a surface via controlled radical polymerization. In an embodiment, radical forming groups can be used to affect crosslinking between polymer chains grafted from a surface via controlled radical polymerization, e.g., atom transfer radical polymerization (ATRP).

In an embodiment, the radical is functional to tethers the polymer to a surface.

In an embodiment, the first polymer and/or the second polymer comprise an active group.

In an embodiment, active groups are provided by monomers comprising precursors of biocidally active groups including, without being limited thereto, 2-(dimethylamino)ethyl methacrylate (DMAEMA), 4-vinyl pyridine, 2-vinyl pyridine, N-substituted acrylamides, N-acryloyl pyrrolidine, N-acryloyl piperidine, acryl-L-amino acid amides, acrylonitriles, methacrylonitriles vinyl acetates, 2-hydroxy ethyl methacrylate, p-chloromethyl styrene, and derivatives and substituted varieties of such monomers.

In an embodiment, a polymer comprising one of these monomeric compounds is converted to a corresponding of quaternary amine.

In an embodiment, the DMAEMA is used as an exemplary monomer unit.

As used herein, the term “polymer” refers to a compound having multiple repeat units (or monomer units) and includes copolymers (including two, three, four or more monomer repeat units). Likewise, related terms such as “polymerization” and “polymerizable” include “copolymerization” and “copolymerizable”.

The term “ATRP” refers to a living/controlled radical polymerization described by Matyjaszewski in the Journal of American Chemical Society, vol. 117, page 5614 (1995), as well as in ACS Symposium Series 768, and Handbook of Radical Polymerization, Wiley: Hoboken 2002, Matyiaszewski, K and Davis, T, editors, the disclosures of which are hereby incorporated by reference.

In another embodiment, the present invention provides that the spacer is adapted to induce turbulent flow regime even in very low velocities. In another embodiment, the present invention provides that the spacer is adapted to induce a quasi-turbulent flow. In another embodiment, the present invention provides that the spacer is adapted to decrease the concentration polarization phenomena. In another embodiment, the present invention provides that the spacer is adapted to increase the surface area of fluid stagnation and propensity to biofouling.

Unless otherwise stated, the following terms used in this application, including the specification and claims, have the definitions given below. It must be noted that, as used in the specification and the appended claims, the singular forms “a”, “an” and “the” include plural referents unless the context clearly dictates otherwise. In this application, the use of “or” or “and” means “and/or” unless stated otherwise. Furthermore, use of the term “including” as well as other forms, such as “have”, “having”, “include”, “includes,” and “included,” is not limiting. The section headings used herein are for organizational purposes only and are not to be construed as limiting the subject matter described. In another embodiment, the term “comprising” is “consisting”.

Unless otherwise stated, the term “about” means±10%.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

### EXAMPLES

Generally, the nomenclature used herein and the laboratory procedures utilized in the present invention include chemical, molecular, and microbiology techniques. Such techniques are thoroughly explained in the literature such as: “Series: Advances in Polymer Science”, Vol. 224 Meier, Wolfgang Peter; Knoll, Wolfgang (Eds.) 2010.

### Example 1

### Biocidal Membranes

Composite nanoparticles and microparticles having Zn and Ag oxides are described.

Escherichia coli CN13 and Pseudomonas putida S-12 were used as model bacteria. The materials were tested under static or flowing conditions as indicated.

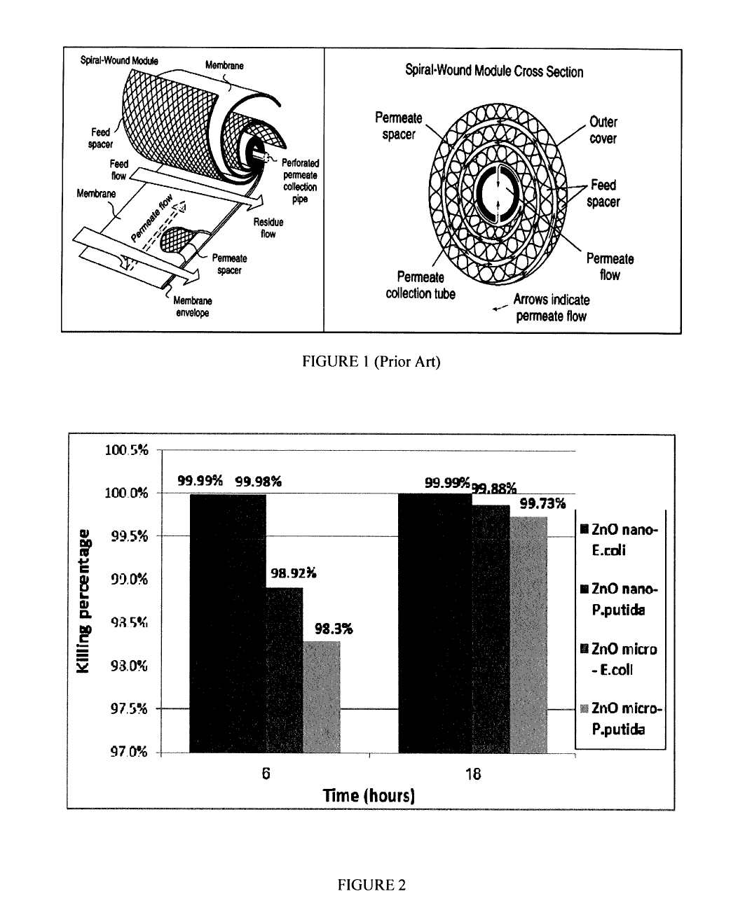

First, the antimicrobial (killing) activity of micro and nano ZnO particles in slurry was evaluated on the model microorganisms as function of the contact time (FIG. 2). It can be seen that the nanoparticles show superior antimicrobial activity compared to the microparticles.

Next nanoparticles having antimicrobial activity were embedded and coated on polymers by several methods, including electrodeposition on a gold coated-commercial polypropylene-PP spacer (ZnO), sonochemical deposition on polyprolpylene-PP (ZnO), Casting on polymethyl methacrylate-PMMA (Ag₂O, ZnO), and entrapment in polyacrylamide-PAA(Ag₂O, ZnO). Following the above mentioned method, a polymeric matrix embedded with nanoparticles having antimicrobial activity was formed.

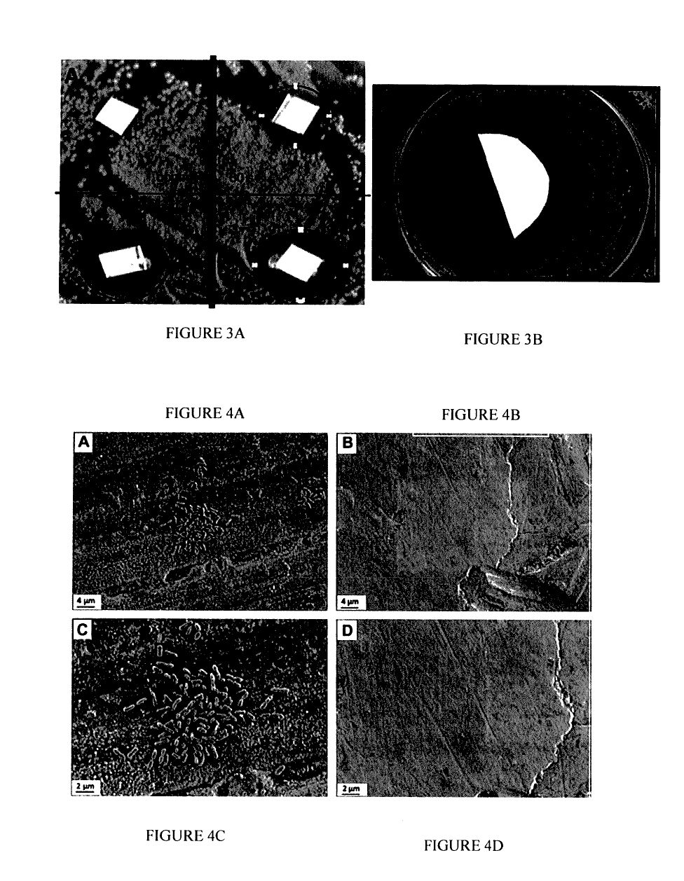

The antibacterial activity of these PMMA samples containing ZnO particles embedded in the polymer matrix (casting) and ZnO electrodeposited on aluminum plates (surface coating) were tested on the model bacteria by the inhibition zone method in static conditions (10⁶ CFU/ml E. Coli CN13 and P. putida S-12 were inoculated into LB agar-plates). In both cases a clear inhibition zone was observed, whose radius increased as a function of ZnO concentration (FIGS. 3A-B).

The ability of the composite material to prevent or decrease biofilm formation was further tested under flow-through regime in a laboratory setup under controlled and defined conditions, employing P. putida S-12 as model bacterium. This bacterium has proven capabilities for biofilm formation in flowing systems. The experiments were performed in the range of inoculated bacteria of 10³-10⁸ CFU/ml and laminar flow (Re=40-600).

The ability of ZnO-PMMA casting-composite film to prevent biofilm and adhesion at an initial bacteria concentration of 10³ CFU/ml and Re-600 is depicted in FIGS. 4A-C (A. Ronen et al. DWT 2012). Flow rate were kept in a laminar regime to simulate the flow in the filtration systems.

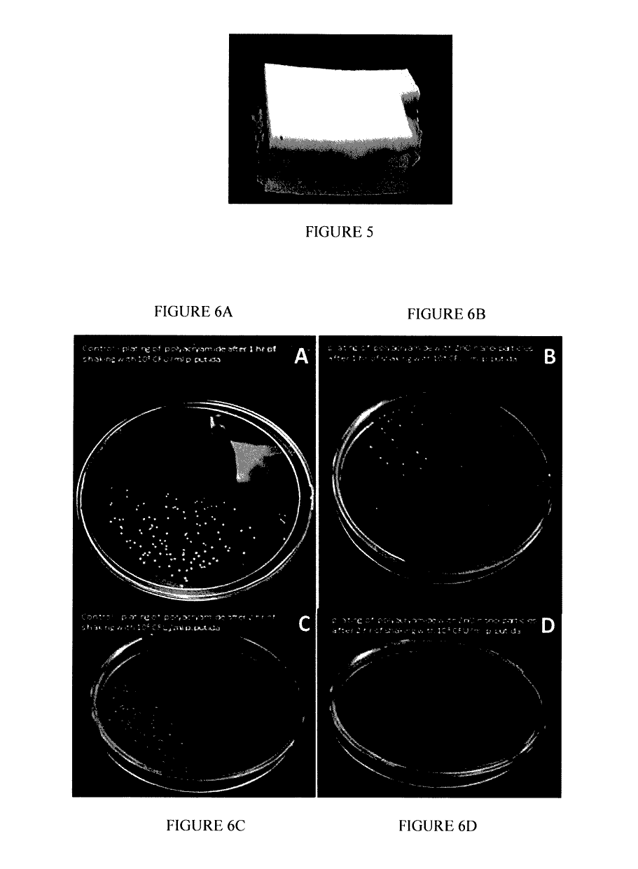

In order to prove the antibiofouling effect of the composite materials, a polyacrylamide (PAA) gel containing 3% (w/w) ZnO-np on its surface, mimicking an anisotropic composite-porous medium, was synthesized (FIG. 5, A. Ronen et al. DWT 2012). First, the antimicrobial activity of the PAA composite was tested in static liquid cultures for 1 and 2 hours while incubating with 10⁶ CFU/ml of P. putida S-12 (FIGS. 6A-D). Following this incubation, samples of the liquid were plated on LB medium for living cell counts. Results indicate that after 2 hours of contact there were no living bacteria left. One hour of contact reduced the population by more than 95%.

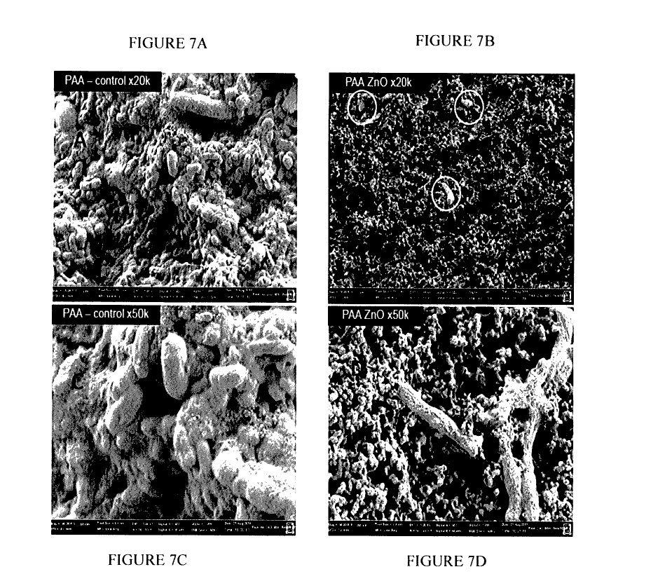

A full run in flowing conditions of the PAA-ZnO-np composites films with a high concentration of P. putida S-12 (10⁸ CFU/ml) for 72 hours is presented in FIGS. 7A-D (A. Ronen et al. DWT 2012). Results indicated that only few bacteria remained attached to the PAA-ZnO surface compared to the developed biofilm found in the PAA—control after 72 hours. The fact that the remaining attached bacteria do not developed into a biofilm suggests that these are dead cells.

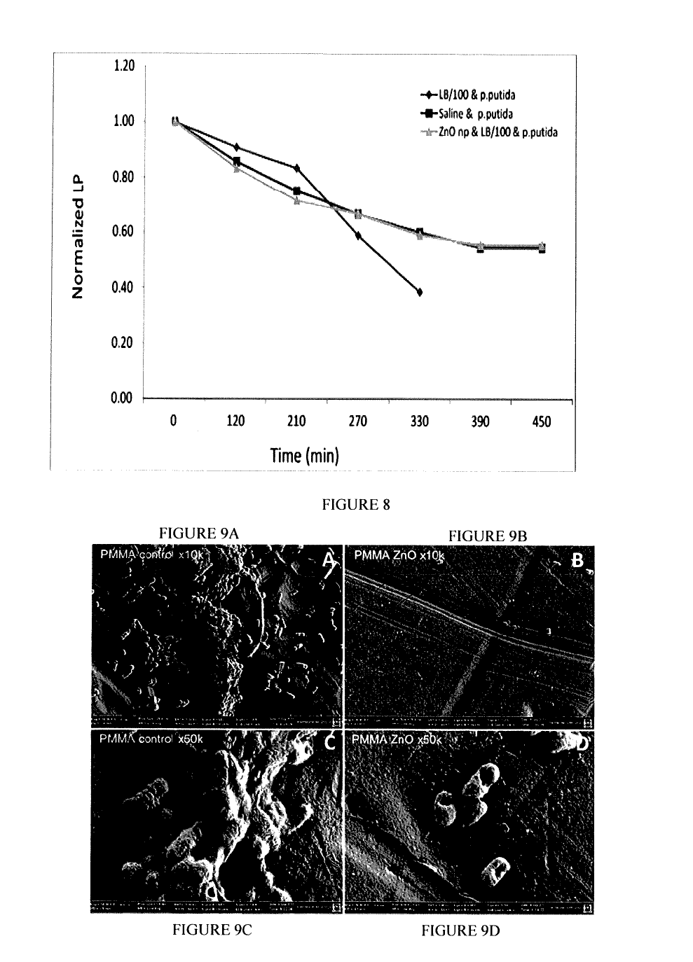

The influence of ZnO-np on membrane biofouling was tested, both in dead end and cross-flow regime. FIG. 8 shows the permeability decline with time on a 200 KD Polysulfone membrane fed with a 10⁵ CFU/ml P. putida S-12 suspension. As seen in FIG. 11, no effect on permeability was observed when ZnO-np were embedded in the membrane fed with bacteria suspended in diluted LB medium compared to the reference run with bacteria suspended in saline under sterile conditions. The decrease observed is due to colloidal deposition of single suspended bacteria. In contrast, in the control run (diluted LB media, absence of ZnO-np) a steep decrease in the permeability was faced and the membranes become completely clogged after 330 min. Due to the high pressure buildup inside the filtration cell (higher that the pump pressure) filtration was stopped and the run stopped.

The antibiofouling effect of a custom spacer (feed side) made from casting PMMA-ZnO-np, was tested in cross-flow regime on a 200 KDa polysulfone membrane, mimicking a real membrane module configuration, is presented in FIGS. 9A-D (A. Ronen et al. DWT 2012). The runs were performed in laminar regime (Re-600) with 10⁸ CFU/ml of P. putida for 72 hours. A PMMA custom made spacer without ZnO-np served as control.

At the end of the runs, the spacer was removed and the membranes were tested by SEM. It can be seen that the composite PMMA-ZnO np spacer significantly decreased the amount of bacteria attached to the membrane. These results indicate that only few bacteria remained attached to the membrane surface compared to the biofilm developed found in control after 72 hours. The fact that the remaining attached bacteria do not developed into a biofilm suggest that they are dead cells. In contrast the control shows typical biofilm colonies.

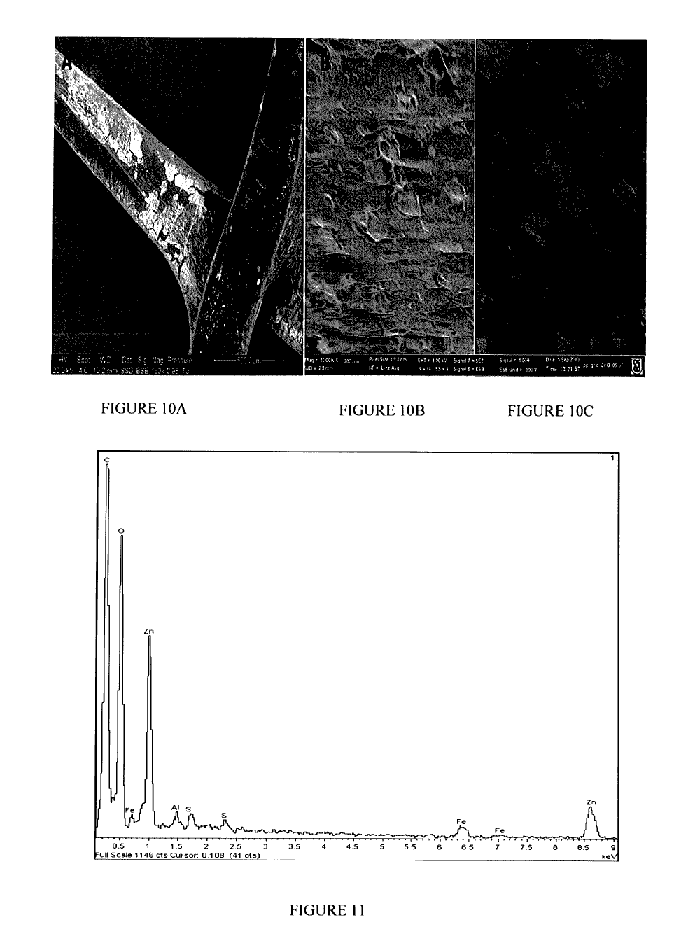

A commercial spacer was coated with ZnO using sonochemical deposition (3 hr in Zinc acetate dehydrate 0.05 M solution). Analysis of ZnO dispersion in the coated spacers revealed significant amounts of ZnO on surface, evenly distributed (FIGS. 10A-C). FIG. 11 further provides the EDS analysis of the embedded ZnO material. Specifically, this HRSEM-EDS analysis of the modified spacer was performed to confirm the coating composition. The EDS spectrum showed predominance of zinc and oxygen confirming that the coating material on the surface of the spacer is indeed ZnO, rating approx. 10% w/w. It should be noted that the coating is mainly on the upper layer of the sample meaning a high active concentration on the surface. The treated spacer was tested for antibacterial ability by Zone of inhibition and showed clear antibacterial ability (FIG. 12).

The Current modified spacer (MoSp) was further tested for antibacterial abilities in static and in flow conditions. In the direct contact of a bacterial suspension in static conditions experiments, one milliliter of a 10⁸-10⁶ CFU·mL⁻¹ suspension of P. putida S-12 or E. coli CN₁₃ in saline, was seeded on the specimen for the time duration indicated below. Following the contact period, samples of the liquid were plated on LB medium for living cell counts. The results are shown in table 1.

TABLE 1

| | Survival fraction (%) | |
|---|---|---|
| Sample | 3 hours | 15 hours |
| P. putida S12* | | |
| Initial saline | 89 | 71 |
| UmSp (unmodified spacer) | 94 | 53 |
| MoSp (modified spacer) | 0.001 | 0 |
| E. coli CN₁₃** | | |
| Initial saline | 80 | 64 |
| UmSp | 78 | 44 |
| MoSp | 0.001 | 0 |

The recorded antibacterial ability in static conditions was also tested using silver as the antibacterial agent. At the same tested parameters all bacteria were eliminated after less than 3 hours.

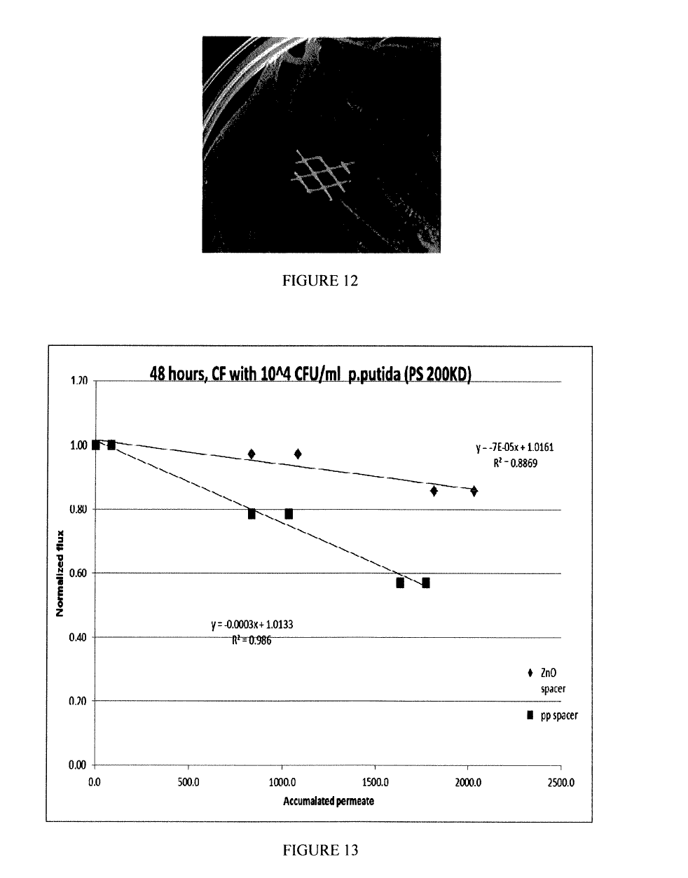

The antibiofouling effect of treated commercial spacer (feed side) was tested in cross-flow regime on a 200 KDa polysulfone membrane. The runs were performed in laminar regime (Re-300) with 10⁴ CFU/ml of P. putida for 72-48 hour. An untreated polypropylene spacer served as control. During the runs, permeate flux was tested. It can be seen that the treated spacer shows a slower decrease in permeate flux compared to the untreated spacer (FIG. 13). The normalized flux of the treated spacer was 52% higher than the untreated one after 48 hours of run.

Leaching of Zinc from the spacer was tested. Treated spacer samples were immersed in DI (Deionized water) for 14 days. Samples were tested after 7 and 14 days by ICP for Zinc presence. The results showed negligible leaching (0.013% and 0.019%, respectively). A further experiment wherein the leaching of Zn was tested in DI and synthetic sea water (SSW) for 7 and 14 days at room temperature (25° C.), was performed. Samples sized 1 cm×1 cm were cut from the spacer and immersed in 50 mL of the tested solutions. The samples were shaken at 150 rpm during the length of the tests. At the indicated times, the solutions were sampled and the content of zinc was determined by ICP. The below tables 2 and 3 summarize the encouraging results:

TABLE 2

| | Initial Zinc | Leaching after | | Leaching after | |
|---|---|---|---|---|---|
| | concentration | 7 days | | 14 days | |
| Water | C₀ | C₇ | Leaching | C₁₄ | Leaching |
| Matrix | (mg/l) | (mg/l) | (%) | (mg/l) | (%) |
| DDW | 10000 | 0.7015 | 0.0007 | 1.05 | 0.001052 |
| Synthetic | 10000 | 0.8525 | 0.00085 | 1.15 | 0.00115 |
| sea water | | | | | |

Same parameters were tested for silver leaching but with more solutions: DI, synthetic sea water, and water at pH values of 3 and 12.

TABLE 3

| | Leaching after | Leaching after |
|---|---|---|
| Water | 7 days | 14 days |
| matrix | (mg/l) | (mg/l) |
| DDW | ~0.1 | ~0.1 |
| Synthetic | 0.18 | 0.15 |
| sea water | | |
| pH 3 | 0.025 | 0.04 |
| pH 12 | 0.22 | 0.25 |

These results illustrate the antibiofouling activity of the different composites tested under different flow conditions, either by direct application or as a spacer for preventing biofouling development on an adjacent membrane. Thus the invention has tremendous advantage over the state of the art.

Further experiments that were conducted with intact modules comprising membranes revealed that the modified spacer completely inhibits colonialization of bacteria on the adjacent polysulfone membrane.

Moreover, the current results are superior compared to the state of the art such as United States patent application US2011/0120936 which shows data collected over 168 hours of contact. After 24 hours, attachment was 2.9×10⁶±2.9×10⁵ cells/cm² on the PP graft-GMA-IDA modified sheet versus 4.0×10⁷±2.1×10⁶ cells/cm2 on the virgin PP sheet.

Similar results were obtained at 96 hours, 3.1×10⁷±2.2×10⁵ cells/cm² on the PP-graft-GMA-IDA modified sheets; and 9.1×10⁸±3.9×10⁶ on the virgin PP sheets. The results at 168 hours were 4.5×10⁷±4.9×10⁴ on the PP-graft-GMA-IDA modified sheets; and 3.7×10⁸±1.1×10⁵ on the virgin PP sheets.

The number of cells attached to the PP-graft-GMA-IDA modified sheets was approximately an order of magnitude lower than those attached to the virgin PP sheets. While the PP-graft-GMA-IDA modified sheets were able to decrease the bacteria concentration by an order of magnitude compared to the virgin PP sheets (after 24 h), the current biocide modified spacer (MoSp) technology unexpectedly revealed complete elimination of bacteria at the same initial concentrations in less time, indicating a 6-7 orders of magnitude reduction compared to the state of the art.

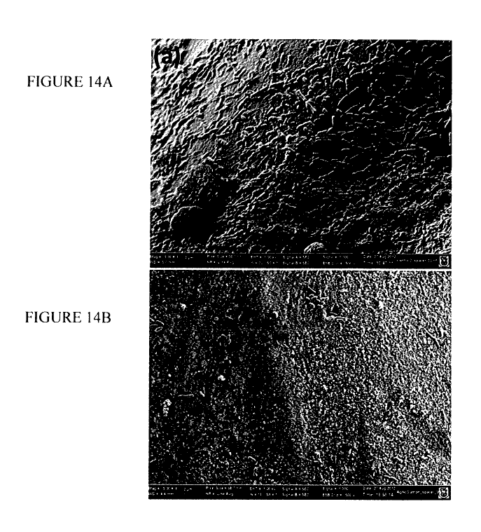

Similar experiments were performed with a silver embedded spacer. FIGS. 14A-B further show that a silver modified spacer inhibits the formation of biofilms whereas unmodified spacer served as excellent bedding for bacteria. A further experiment with an intact module revealed that the spacer inhibits the colonization of bacteria on the adjacent polysulfone membrane (FIGS. 15A-B). Parallel results were obtained with modules having copper modifies spacers.

In conclusion, the modified spacer (such as spacers embedded with ZnO or silver) showed strong, antibacterial abilities in static and flow conditions with less leaching of antibacterial agents.

This phenomenon was also apparent when the filtration module was assembled. Specifically, the membranes contacting a spacer were also resistant to bacterial attachment and growth thus rendering the filtration module extremely bacterial resistant and far more effective than other modules described in the prior art. Moreover, permeate flux decrease of the filtration module was hindered and leaching was minimized, when compared to biocide modified membranes.

### Example 2

### Silver Flow Experiments

### Materials

Flow experiments were performed using a mixed bacterial culture enriched from a continuous pilot plant membrane bioreactor (Zenon) running on domestic wastewater at the Technion campus by successive cultivation in synthetic tertiary effluents medium.

Feed Spacer Modification with Nanosilver:

Briefly, cleaned samples were immersed in 0.04 M silver nitrate solution with 10% [v/v] ethylene glycol, 90% DI (deionized) water. An aqueous solution of 24% ammonia was added dropwise to the reaction slurry during the first 3 min of sonication. Samples were ultrasonicated for 180 minutes (100% intensity) using an ultrasonic horn tip (Vibra Cell 130, 20 KHz) at a controlled temperature of about 15° C. using a cooling bath. After modification, the spacers were first washed thoroughly with deionized water to remove traces of ammonia, and then with ethanol. Modified spacers were dried overnight at room temperature. Silver coating coverage was assesed by image analysis of HRSEM images (ImageJ v.1.46r) and silver loading was determined by gravimetric analysis.

Assessment of Bacteria Concentration by TOC Measurements:

Concentration of the bacteria attached to the membranes was evacuated by TOC (total organic carbon) measurement (TOC-V series, Shimadzu). Section of the membranes (1.5 cm²) were cut and placed in a 4.5 mL sterile saline containing 0.5% w/w tween-80 and 2.5 gr of sterile glass beads. Samples were vortexed for 40 seconds and afterwards the solution was tested for TOC concentration. Experiments were repeated at least 3 times. Bacteria concentration was estimated by considering a single bacterial cell of spherical shape of approx. 1 μm diameter and 1.03 g·cm⁻³ density. The estimated cell volume will be 0.52×10⁻¹² cm³ and the cell mass will be 0.54×10⁻¹² g per cell. Considering that approx. 30% of the cell weight is dry material and containing 90% organic material of which approx. 58% is C, the amount of organic carbon per cell comes to 8.5×10⁻¹² μg C per cell.

### Silver Leaching Tests:

Silver leaching is an important factor influencing the potential activity of the modified spacer and its life span. Leaching was tested in several water matrix which represent typical working and cleaning conditions, such as deionized water, synthetic seawater, acidic and basic water solutions (pH 2 and pH 13, respectively). Sections of the spacer (1 cm²) were immersed in 50 mL of the tested solutions for seven and fourteen days at room temperature. To ensure mixing and contact, the samples were shaken at 150 rpm during the length of the tests. At several time points, the solutions were sampled and silver concentration was determined by inductive coupled plasma (ICP).

### Results

### Characterization of the Nanosilver-Modified Spacers

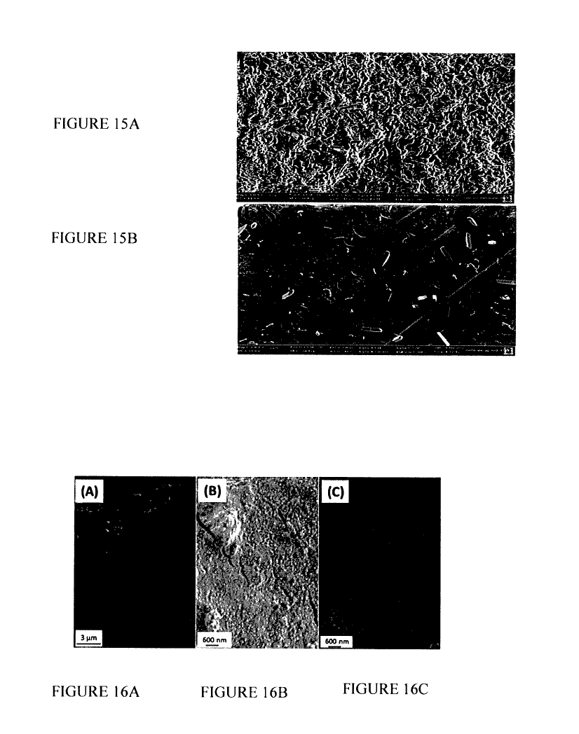

Characterization of the spacers was first performed through imaging by HRSEM (FIGS. 16A-C).

The unmodified spacer surface shows a single, low density component, typical for a carbon-based material such as polypropylene (FIG. 16A).

Calculation of the area coated by silver using image processing of the secondary electron (SE) imaging indicated 90-99% surface coating (FIG. 16B). Backscattered secondary electron (BSE) imaging indicates that most of the particles on the polypropylene surface are nano-sized with fewer, larger particles (FIG. 16C). Silver loading was estimated by gravimetric analysis to be 9% w/w (by total weight of the spacer).

Leaching of silver ions from the modified spacers was next evaluated. The release of silver ions is related to the life span spacer. Leaching from the modified spacer was assessed in equilibrium conditions against deionized water, synthetic seawater, as well as acidic and basic (pH of 3 and 12, respectively) solutions. Samples were taken after seven and fourteen days (see Table 4, showing the leaching of silver ions from the nanosilver-modified spacers).

TABLE 4

| | Dissolved silver concentration (mg · L⁻¹) | | | Average |
|---|---|---|---|---|
| | | | Average | daily |
| Water | After | After | daily | weight loss |
| matrix | 7 days | 14 days | leaching | (%) |
| Deionized | 0.078 ± 0.005 | 0.106 ± 0.008 | 0.013 | 0.016 |
| water | | | | |
| Synthetic | 0.177 ± 0.001 | 0.128 ± 0.005 | 0.022 | 0.028 |
| seawater | | | | |
| pH = 3 | <0.02 | 0.025 ± 0.002 | 0.002 | 0.003 |
| pH = 12 | 0.243 ± 0.08 | 0.263 ± 0.05 | 0.033 | 0.041 |

Results indicate that a small concentration of silver was released to the solution after 7 and 14 days in all water matrixes leading to the conclusion that the leaching is quite small. Silver leaching was at an average rate of 0.013±0.008 mg·L⁻¹ per day on deionized water, 0.022±0.005 mg·L⁻¹ per day on synthetic seawater, a higher rate of about 0.033±0.005 mg·L⁻¹ per day for basic water solutions (pH 12) and a negligible concentration of 0.002±0.001 mg·L⁻¹ per day for acidic water solutions (pH 3). Based on these characteristics, it is estimated that silver is released at a rate of 0.003-0.04% w/w per day. Therefore, a modified spacer with 9% w/w silver loading should suffice for the predicted life span of the membrane module in the current conditions.

The antibacterial properties of the modified spacers were determined in static liquid cultures following 1, 2, 3 and 6 hours of direct contact (see Table 5 showing the antibacterial activity test against P. putida S12 in static liquid cultures.). An affective bacterial reduction was seen even after 1 hour of direct contact (93% reduction) compared with no reduction observed in the control samples. Practically complete bacterial reduction (8-logs) was observed after 3 hours, compared with a 40-55% reduction in the control. All control samples showed a reduction of up to 50% after 6 hour due to natural bacterial decay as assessed by viable cell plating.

TABLE 5

Survival fraction (%)

| Sample⁽¹⁾ | 1 h | 2 h | 3 h | 6 h |
|---|---|---|---|---|
| Control saline | 100 | 76 | 60 | 53 |
| Unmodified spacer | 100 | 70 | 45 | 45 |
| Modified spacer | 7 | 3 | ND⁽²⁾ | ND⁽²⁾ |

⁽¹⁾Initial bacteria concentration was about 10⁸ CFU · mL⁻¹ in saline.
⁽²⁾ND: not detectable.

### Antibiofouling Activity of the Modified Spacer Under Crossflow Conditions:

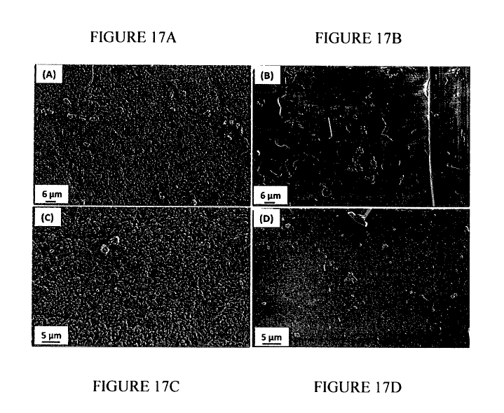

Flow experiments under conditions comparable to field operation (˜10 mg·L⁻¹ TOC and 10³-10⁴ CFU·mL⁻¹ bacterial concentration in the feedwater) were performed to evaluate the antibiofuling capabilities of the modified spacers. Daily samples were taken for enumeration of planktonic bacteria, after 230 hours of experiment the cells were dismantled, and the membranes and spacers autopsied. FIGS. 17A-D shows HRSEM micrographs of the autopsied membranes adjacent to the spacers. The membrane near the unmodified spacer displayed a developed biofilm structure covering almost all the surface area (FIG. 17, panels A, C). In contrast, the membrane adjacent the modified spacer displayed only small patches of attached bacteria in a monolayer structure (FIG. 17, panels B, D). The area coverage of the biofilm was estimated to be approximately 87.2% and 2.4%, on the membranes adjacent to the unmodified spacer and modified spacer, respectively. These results indicate a high antibiofouling potential of the modified spacers. Biofilms developed in a multilayer structure while area coverage was evaluated by 2D imaging, therefore, additional semi-empirical estimation of bacteria concentration on the membranes was performed based on TOC measurements. The average bacteria concentration calculated was 260±8.6 and 13±12.5 cells per 100 μm² for the control and treatment, respectively, which is in line with the estimated area coverage. Overall, the membrane near the modified spacer exhibited 10-20 folds less attached bacteria per area than the control membrane.

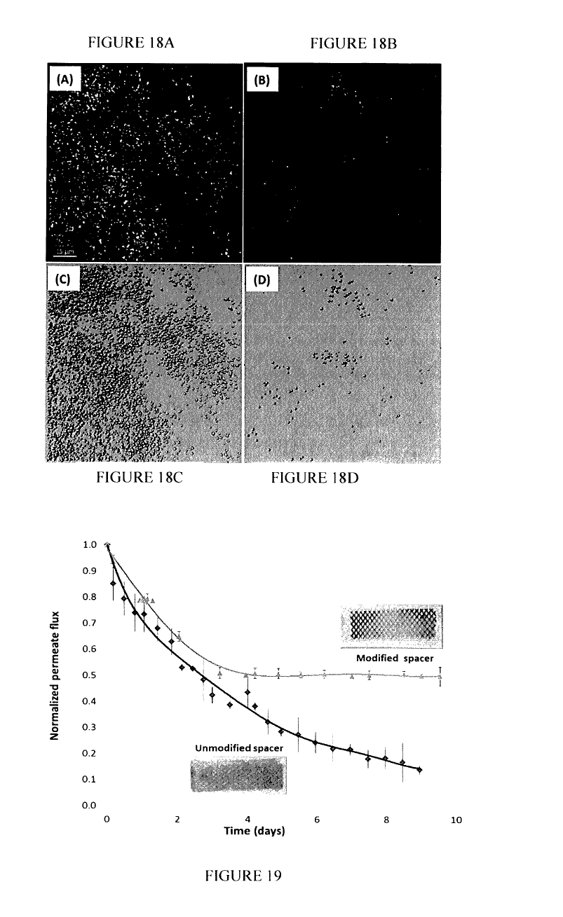

In addition to bacteria concentration and surface coverage, dead/live staining and imaging by CLSM was performed (FIGS. 18A-D). Dead bacteria were stained by PI and live bacteria were stained by CTC. Estimation of the attached cells was done using image analysis (Imaris software) which distinguishes between individual cells (see Table 6 showing estimation of dead/live attached bacteria on the membrane by CLSM). It can generally be seen that the membrane near the unmodified spacer exhibited large clusters of bacteria, most of which were alive (12% dead). In contrast, the membrane near the modified spacer showed significantly less bacteria attached to the surface, of which 27% were dead.

TABLE 6

| | | | |
|---|---|---|---|
| Live | Dead | Dead/ | Dead/ |
| bacteria | bacteria | Live | Total |

| | | |
|---|---|---|
| Spacer | (Cells/100 μm²) | (%) |

| | | | | |
|---|---|---|---|---|
| Unmodified | 2525 ± 180 | 354 ± 74.8 | 14 | 12 |
| (control) | | | | |
| Modified | 248 ± 98 | 92 ± 61 | 37 | 27 |

FIG. 19 presents the measured permeate flux vs. time for multiple experiments. An intrinsic self-decrease of permeability was observed for approx. 3 days until the system stabilized. After 10 days of flow, the permeate flux of the membrane with the modified spacer was almost 5-fold higher (about a 45% flux decline) than that obtained with the unmodified spacer, (90% decline). The change in permeate flux during the experiments can be mainly attributed to the deposition of bacteria and biofilm development on the membranes. Images of the membranes and spacers at the end of the experiment are presented in the insets of FIG. 19. A thick ‘gel’ biofilm layer can be seen on top of the membrane near the unmodified spacer while significantly less biofilm can be seen on the membrane adjacent to the modified spacer.

### Example 3

### Numerical Simulation of Velocity Field and Silver Ions Distribution

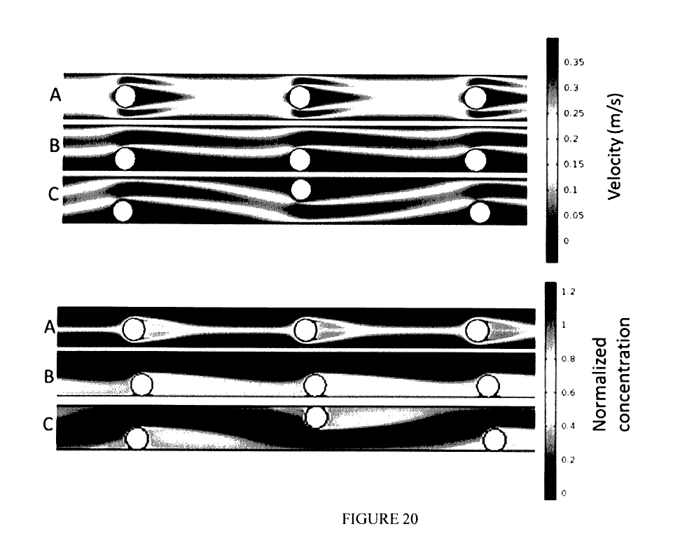

Representative plots of the velocity field, obtained by the numerical simulation of the flow near and around spacers with three possible configurations are presented in FIG. 20 (top panel). The spacer decreases the available area for flow, and therefore, the velocity above and below the spacer increases in the submerged configuration. In the zigzag and cavity configurations the flow velocity increased opposite to the spacer's location and significantly decreased near the spacer thus, increasing stagnation points and low flow velocities near the membrane surface.

The distribution of silver ions released from the spacer along the feed channel is presented in FIG. 20 (bottom panel).

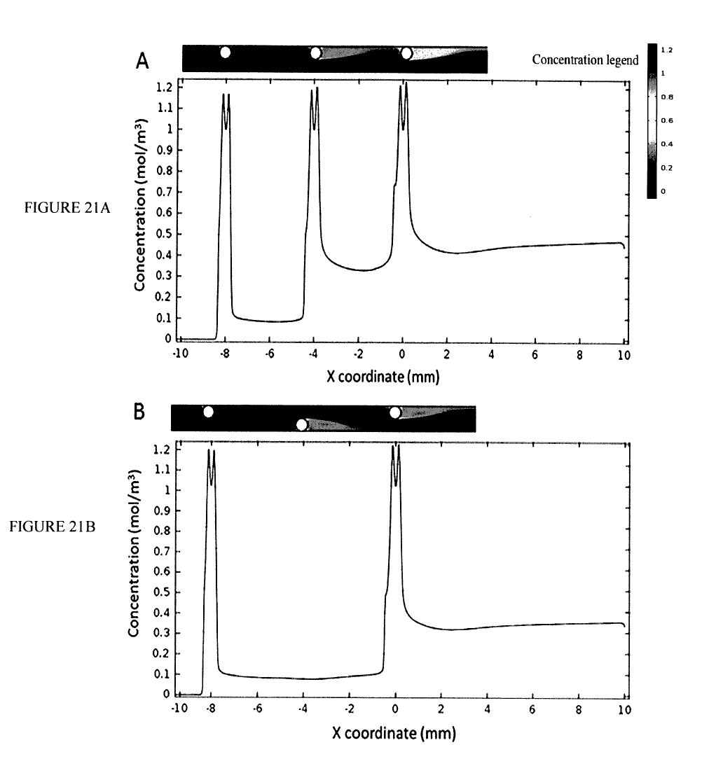

Silver ion concentrations were evaluated near the upper membrane surface for both cavity and zigzag configurations (FIGS. 21A-B), as the concentration near the membrane has significant influence on the antibacterial capacity of the spacer. Results indicate that for the cavity configuration, 50% of the spacer-interface concentration is reached near the upper membrane after about 1.2 cm of flow (˜3 repeating units of spacer). In the zigzag configuration only 35% is reached at the same distance but the opposite membrane is affected as well. Overall, the silver concentration near the membrane is relatively high after a short distance. It should be noted that the modified spacer used for the experiments was significantly longer than the simulated flow channel (˜80 mm). As spacer units are placed about 4 mm from each other, the experimental system was based on more than 20 continuous spacer units.

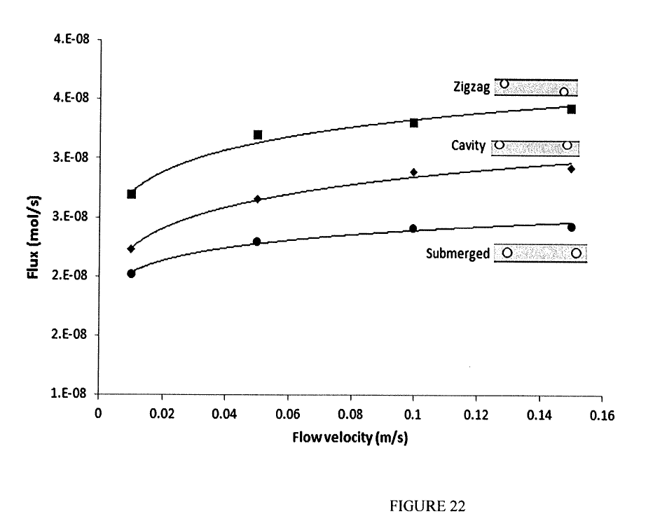

The silver ion flux (in mole/s), released from the spacer, was calculated per single unit of the spacer (taken as a cylinder with a radius of 2.5 mm) as a function of the crossflow velocity (0.01-0.15 m·s⁻¹). The ion flux was calculated for the third unit of spacer in the flow channel as this spacer unit simulates developed hydrodynamic conditions (in the periodic sense) while also accounting for the influence of the silver ions released from the previous spacer units. Simulations indicate that ions flux is influenced by the concentration gradient near the spacer, and therefore, the flux increases with correlation to the crossflow velocity in the channel (see FIG. 22). Furthermore, the lowest flux was found for the cavity configuration and the highest values were obtained for the zigzag configuration as it is subjected to a lower concentration of silver ions from the previous spacer units.

### Example 5

### Binding Quaternary Ammonium Group to the Spacer

### Method

### Materials:

Dimethylaminoethyl methacrylate (DMAEMA) was purchased from Sigma-Aldrich and passed through a basic alumina column immediately before use. CuCl was purchased from Sigma-Aldrich and purified by stirring in glacial acetic acid overnight, filtering, and washing with dry ethanol. It was kept in a dry environment. Ethyl 2-bromoisobutyrate (EBriBu), CuCl₂, 1,1,4,7,10,10-hexamethyltriethylenetetramine (HMTETA), and all other chemicals were purchased from Sigma-Aldrich and used without further purification.

Flow through experiments were performed using a mixed bacterial enrichment from a domestic wastewater reactor running at Technion-IIT campus by successive cultivation in synthetic tertiary effluents medium. Flat sheet polysulfone membranes of 200 kDa molecular weight cut off (MWCO) were obtained from GE Osmonics (ymersp3001).

### Feed Spacer Modification:

Polypropylene (PP) feed spacers were harvested from a commercial 8″-spiral-wound membrane module (Toray) as described herein. The feed spacer thickness was about 680 μm with strands intersecting at 90° and an average porosity of about 0.80-0.85. The spacers were cut to fit the flow cell size (8 cm×3 cm). Modification of the pQAs spacers was performed using atom transfer radical polymerization (ATRP) followed by amine quaternization.

### Quaternary Ammonium Spacer Modification

### Initial Grafting on the PP Spacer:

Spacers samples were immersed in deionized water (DI) and sonicated by an ultrasonic bath for three cycles of 30 min at room temperature, followed by overnight cleaning via Soxhlet extraction with dichloromethane (DCM). Benzophenonyl 2-bromoisobutyrate (BPBriBu) was dissolved in toluene by heating (2.9 mmol in 20 mL). The spacer was dipped in the BPBriBu solution, air dried at room temperature and irradiated for 2.5 minutes with a 2 kW, main wavelength at 365 nm, high pressure mercury UV lamp (model RW-UV.3BP, Run Wing M&E Inc.). Samples were cleaned again via Soxhlet extraction with DCM for 24 hours.

Poly(2-Dimethylaminoethyl Methacrylate) (pDMAEMA) Chain Growth:

20 mL (0.6 mol) of DMAEMA, 44 μL (0.3 mmol) of EBriBu, 0.1 mL (0.36 mmol) of HMTETA, and 6 mL of acetone were mixed in a 250 mL Schlenk flask. The system was subjected to 3 freeze-pump-thaw cycles. Then 8.1 mg (0.06 mmol) CuCl₂ and 30 mg (0.3 mmol) CuCl were added under a nitrogen environment and stirred at room temperature for 28 hours. Solid spacers were removed and cleaned via Soxhlet extraction with DCM for 24 hours.

Quaternization of pDMAEMA:

The PP-g-pDMAEMA spacers were submerged in a 50% bromoethane-50% acetonitrile [v/v] solution for 24 hours, thereafter were washed with acetone, water and dried overnight at room temperature. Polymeric quaternary ammonium ligands of the modified PP spacers were characterized by FTIR (Bruker Tensor 27) using attenuated total reflectance (ATR) module and compared to control PP spacers.

### Results

### Quaternary Ammonium Modification

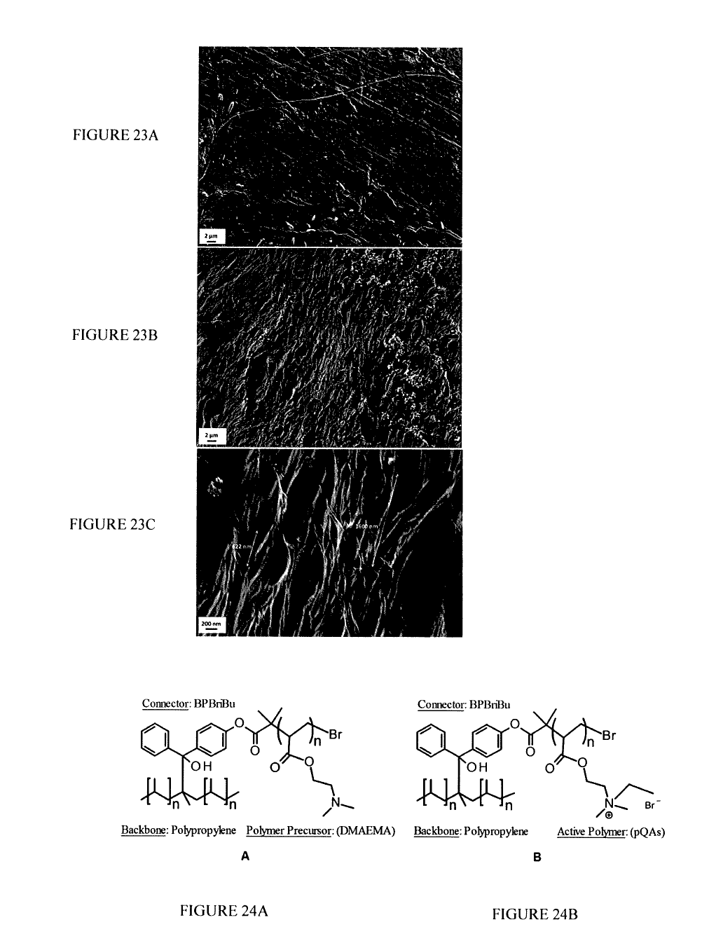

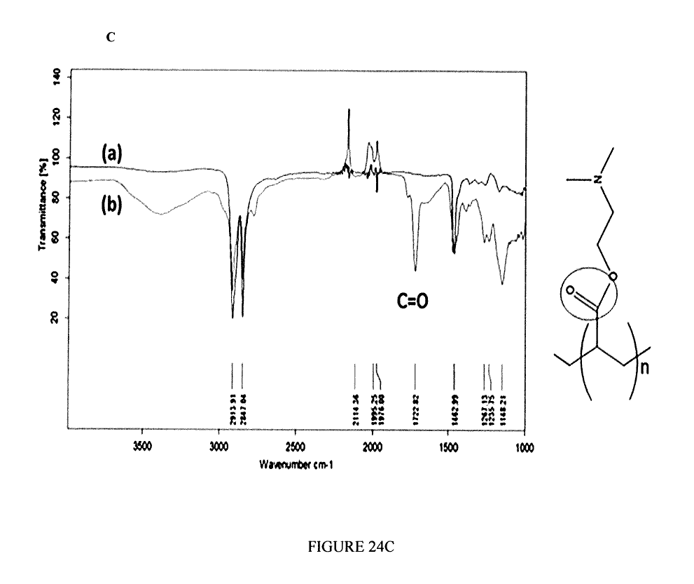

The polyquaternary ammonium modification of the polypropylene spacers is presented in FIGS. 23A-C and is summarized in the schemes of FIGS. 24A-B. The reaction was terminated by exposure to air after 28 hours. This reaction time was found the most favorable in terms of reaction duration to ligand growth and density. Further increase in reaction time led to a negligible increase in growth efficiency, i.e., ligand length and QA density. Therefore, according to the experimental conditions, the typical QA density was estimated at about 9×10¹⁶ N⁺/cm², the length of the QA ligands was estimated to up to 1.6 μm according to high magnification-HRSEM images (FIG. 23C).

HRSEM images of the modified spacer surface (FIG. 23B) depicted a significant morphological difference in comparison to the control (FIG. 23A). Indeed, whereas the control surface displayed a relatively smooth surface, the pQA modification altered the surface resulting in a dense array of protuberances resembling nano-brushes, as a result of the pDMAEMA growth.

Verification of the chemical bonds found in the modified surface using FTIR (FIG. 24C) indicated the growth of pDMAEMA on the PP surface by the carbonyl bonds which can be seen around 1722 cm⁻¹ wavelength.

### Example 6

### Comparative Antibacterial Tests: Silver and PQA Coating

### Antibacterial Tests of the Modified Spacers in Static Conditions:

Both modified spacers displayed a powerful antibacterial potential in static liquid culture compared to the controls (see Table 7 showing the antibacterial potential of the modified spacers measured in static liquid cultures.). The pQA modified spacer achieved a bacterial count reduction of 99% and the nAg of 93% after 1 hour of incubation compared to approx. 5% natural decay of the controls. Furthermore, both modified spacers showed practically complete bacterial reduction after 2-3 hours (8 and 5 logs for nAg and pQAs respectively).

TABLE 7

| | Relative survival fraction [%] | | | |
|---|---|---|---|---|
| | Time [h] | | | |
| Sample | 1 | 2 | 3 | 6 |
| Unmodified | 95.3 ± 6.6 | 89.1 ± 4.3 | 85.0 ± 14.1 | 79.7 ± 7.3 |
| spacer (control) | | | | |
| pQA modified | 0.9 ± 0.0 | 0.9 ± 0.1 | 0.8 ± 0.0 | 0.0 ± 0.0 |
| spacer | | | | |
| nAg modified | 7.1 ± 0.2 | 3.7 ± 0.3 | 0.0 ± 0.0 | 0.0 ± 0.0 |
| spacer | | | | |

The slight differences in the biocidal rates found in our study could be explained by the active mechanism of nAg which requires diffusion of silver ions from the modified spacer to the surrounding water matrix until reaching a minimum inhibitory concentration, while the influence of pQA is instantaneous by direct contact.

To ensure that the antibacterial activity of the pQAs modified spacers is perdurable, static liquid tests were repeated on spacers stored for 7 and 30 days. Between the tests, the modified spacers were stored soaked in DI water. The stored spacers displayed a similar very high antibacterial activity reduction of that tested at time zero (see Table 7). This indicates that the pQA modification is stable, and can be used in repeated applications for a relatively long period.

### Biofouling Reduction Ability of the Modified Spacers in Cross-Flow Filtration

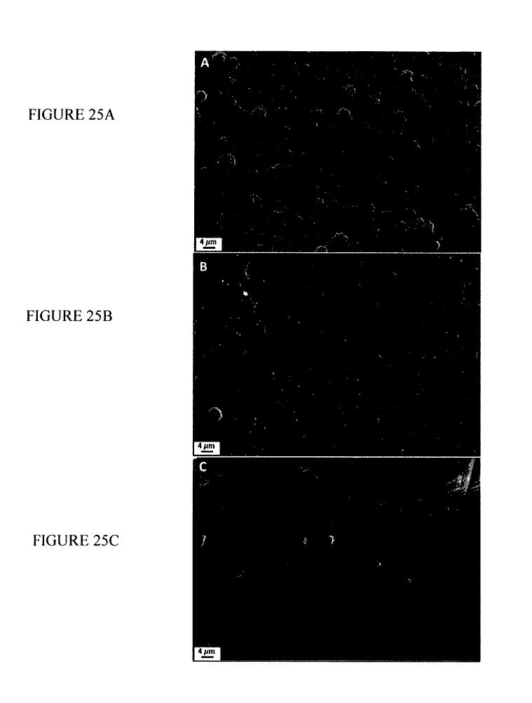

FIGS. 25A-C show HRSEM micrographs of the membranes adjacent to both modified spacers and the unmodified control spacer after 10 days of continuous flow. While the membrane adjacent to the unmodified spacer displayed a developed biofilm structure covering almost all of the surface analyzed (FIG. 25A), both membranes adjacent to the modified spacers displayed significantly less attached bacteria, mostly sporadically dispersed in a monolayer structure. The membrane adjacent to the pQA modified spacer displayed small patches of attached bacteria dispersed in several areas (FIG. 25B) while the membrane adjacent to the nAg modified spacer displayed only a very few single attached bacteria, thoroughly dispersed (FIG. 25C). The approximate percentage of membrane area covered by attached bacteria was calculated to be 89.9±3.1%, for the control, 14.4±5.5% for pQAs and 2.4±1.4% for nAg.

These results indicate an effective antibiofouling effect of the modified feed spacers at cross-flow filtration conditions.

Because of the release of antibacterial active species (e.g., silver cations, ROS), nAg modified spacers have a long-distance antibacterial influence and are effective throughout the whole spatial configuration of the membrane while pQA modified spacers have a more localized influence at the spacer structure.

Calculation of the average concentration of bacteria attached on an area of 100 μm² membrane based on TOC measurements after 230 h flow depicted the following values: 260±8.6 mg/L for the unmodified-control spacers, 45±20 mg/L for the pQA modification and 1.3±8.5 mg/L for the nAg modification. This estimation of attached bacteria by TOC measurement is in line with the HRSEM-image analysis, depicting a similar trend, which highlights the antifouling ability of the modified spacers during cross-flow filtration, in general, and of the nAg modified spacer, in particular.

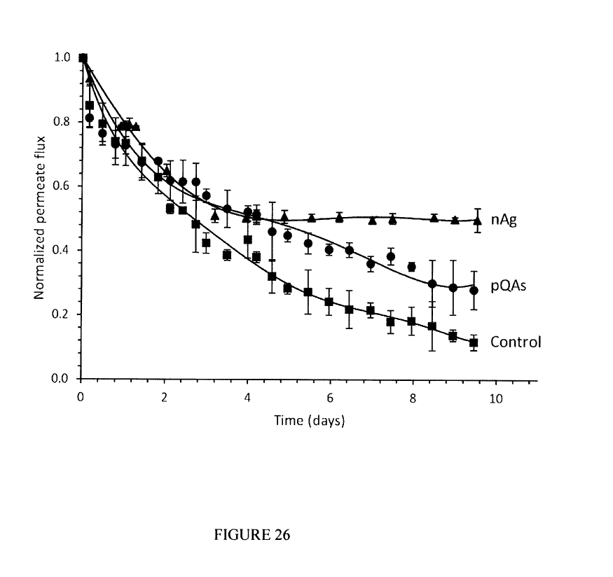

The measured normalized permeate flux during time for multiple experiments is presented in FIG. 26. An inherent self-decrease of permeability was observed for approx. 3 days until the system stabilized. After 10 days of flow, the permeate flux of the membrane with the pQAs modified spacer was almost 3-folds higher (about 55-60% flux decline) than that of the membrane adjacent to the unmodified spacer (90% flux decline) while the membrane with the nAg modified spacer was 5-fold higher (about a 45% flux decline). These changes in permeate flux during the experiments are in correspondence with the bacterial attachment and biofilm development on the membranes presented above.

All in all, the results comprising microscopic visualization, enumeration of attached bacteria and permeate flux measurements indicate that both antibacterial feed spacers are effective in controlling and hindering membrane biofouling during cross-flow filtration. The nAg modification seems to be slightly more efficient in bacteria reduction as they provide a long distance antibacterial activity while the pQAs modified spacer seems to acts locally. It should be noted that even though the experiments were carried out in bench scale system, severe conditions promoting biofouling were applied (experimental setup encouraging biofilm development, continuous feed with high bacterial titer and high organic loading). Commercial RO membranes are subjected to milder conditions and therefore the influence of both modified spacers is expected to be effective also under practical conditions.

What is claimed is:

1. A filtration module comprising two membrane layers and a spacer layer, said spacer layer is sandwiched between said two membrane layers, wherein said spacer layer is in direct contact with said two membrane layers, wherein said spacer layer comprises (i) a polymer; and (ii) a biocide deposited on at least one upper layer surface of said polymer, wherein:
(a) said two membrane layers are devoid of said biocide, and
(b) at least 50% of an area of said upper layer surface of the polymer is covered by said biocide.

2. The filtration module of claim 1, wherein at least 90% of said area of the upper layer surface of said polymer is covered by said biocide.

3. The filtration module of claim 1, wherein said biocide is at concentration that ranges from about 4% to about 30%, by total weight of said spacer layer.

4. The filtration module of claim 1, wherein said biocide is a metal or a metal oxide.

5. The filtration module of claim 4, wherein said metal or said metal oxide are in the form of nanosized particles.

6. The filtration module of claim 4, wherein said metal is silver.

7. The filtration module of claim 4, wherein said metal oxide is zinc oxide (ZnO).

8. The filtration module of claim 1, wherein said biocide is physically deposited on said at least one upper layer surface of said spacer.

9. The filtration module of claim 1, wherein said biocide comprises a quaternary ammonium salt.

10. The filtration module of claim 1, wherein said biocide comprises a quaternary ammonium salt and a metal or a metal oxide.

11. The filtration module of claim 1, having a tubular shape.

12. The filtration module of claim 1, wherein an outer circumference of said filtration module consists of a membrane layer.

13. The filtration module of claim 1, wherein said filtration module is adapted for filtering water.

14. The filtration module of claim 1, wherein said polymer comprises polypropylene.

15. The filtration module of claim 1, wherein said polymer comprises polymethyl methacrylate (PMMA).

16. The filtration module of claim 1, wherein said two membrane layers are characterized by a pore size of 0.2 μm-500 μm.

17. A method for reducing the concentration of bacteria in water, comprising a step of contacting said water with the filtration module of claim 1.

18. The method of claim 17, wherein said filtration module comprises a tubular shape and two permeable or a semi-permeable membrane layers, wherein an outer circumference of said module consists a membrane layer.

19. The method of claim 17, wherein said filtration module comprises a tubular shape and a coiled bilayer, said bilayer comprises a single permeable or semi-permeable membrane layer directly contacting the spacer layer, wherein an outer circumference of said module consists of said membrane layer.

20. The method of claim 17, wherein said filtration module comprises a tubular shape and a coiled bilayer, said bilayer comprises a single permeable or semi-permeable membrane layer directly contacting a single spacer layer, wherein at least 90% of the area of the upper layer surface of said polymer is covered by said biocide.
